(19) United States
(12) Patent Application Publication
(10) Pub. No.: US 2023/0387728 A1
(43) Pub. Date: Nov. 30, 2023

(54) DETERMINING DEVICE COMPATIBILITY USING TAG DEVICES

(71) Applicant: Lenovo (Singapore) Pte. Ltd., New Tech Park (SG)

(72) Inventors: Gary D. Cudak, Wake Forest, NC (US); Nathan Peterson, Oxford, NC (US); John M. Petersen, Wake Forest, NC (US)

(21) Appl. No.: 17/752,556

(22) Filed: May 24, 2022

(51) Int. Cl. H02J 50/80; G06K 7/00; G06K 7/10

(52) U.S. Cl. CPC H02J 50/80; G06K 7/0008; G06K 7/10217

(57) ABSTRACT

Methods, apparatus, and computer program products that determine compatibility between devices using tag devices are disclosed herein. One method includes a processor transmitting a charging signal and receiving a respective response signal from multiple tag devices responsive to the charging signal. Each respective response signal includes configuration data for a particular first device associated with each respective tag device for determining compatibility between each first device and a second device. Apparatus and computer program products that determine compatibility between devices using tag devices are also disclosed herein.

### FIELD

The subject matter disclosed herein relates to computing devices and, more particularly, relates to determining device compatibility using tag devices.

### BACKGROUND

At least some users lack the ability to know what devices are compatible with each other. For example, in a drawer storing multiple chargers, it may be difficult for a user to know which charger(s) is/are compatible with the user's electronic device without the user manually testing each charger. Accordingly, identifying compatible electronic devices can be more difficult than it should be and/or take more time than it otherwise should take.

### BRIEF SUMMARY

Apparatus, methods, and computer program products that include tag devices for determining device compatibility are disclosed herein. An apparatus, in one embodiment, includes a processor and a memory that stores code executable by the processor. In certain embodiments, the code is executable by the processor to transmit a charging signal and receive a respective response signal from each of a plurality of tag devices responsive to the charging signal in which each respective response signal includes first configuration data for a particular first device associated with each respective tag device for determining compatibility between each first device and a second device.

One embodiment of a method that includes tag devices for determining device compatibility includes a processor transmit a charging signal. In some embodiments, the method further includes the processor receiving a respective response signal from each of a plurality of tag devices responsive to the charging signal in which each respective response signal includes first configuration data for a particular first device associated with each respective tag device for determining compatibility between each first device and a second device.

A computer program product that includes tag devices for determining device compatibility includes a computer-readable storage medium including program instructions embodied therewith. In certain embodiments, the program instructions are executable by a processor to cause the processor to transmit a charging signal and receive a respective response signal from each of a plurality of tag devices responsive to the charging signal in which each respective response signal includes first configuration data for a particular first device associated with each respective tag device for determining compatibility between each first device and a second device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIGS. 1A through 1C are schematic diagrams illustrating various embodiments of a computing system that can determine device compatibility using tag devices;

FIGS. 2A and 2B are schematic block diagrams illustrating various embodiments of a device included in the computing systems of FIGS. 1A through 1C;

FIG. 3 is schematic block diagram illustrating one embodiment of a memory device included in the devices of FIGS. 2A and 2B;

FIG. 4 is schematic block diagram illustrating one embodiment of a processor included in the devices of FIGS. 2A and 2B;

FIGS. 5A and 5B are schematic block diagrams illustrating various embodiments of a computing device included in the computing systems of FIGS. 1A through 1C;

FIGS. 6A and 6B are schematic block diagrams illustrating various embodiments of a memory device included in the computing devices of FIGS. 5A and 5B;

FIGS. 7A and 7B are schematic block diagrams illustrating various embodiments of a processor included in the computing devices of FIGS. 5A and 5B;

FIG. 8 is a schematic flow chart diagram illustrating one embodiment of a method for determining device compatibility using tag devices;

FIG. 9 is a schematic flow chart diagram illustrating another embodiment of a method for determining device compatibility using tag devices;

FIG. 10 is a schematic flow chart diagram illustrating still another embodiment of a method for determining device compatibility using tag devices; and

FIG. 11 is a schematic flow chart diagram illustrating yet another embodiment of a method for determining device compatibility using tag devices.

### DETAILED DESCRIPTION

As will be appreciated by one skilled in the art, aspects of the embodiments may be embodied as a system, apparatus, method, or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to emphasize their implementation independence more particularly. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

In addition, as used herein, the term, “set,” can mean one or more, unless expressly specified otherwise. The term, “sets,” can mean multiples of or a plurality of one or mores, ones or more, and/or ones or mores consistent with set theory, unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Various embodiments disclosed herein provide apparatus, methods, and computer program products that can determine device compatibility using tag devices. An apparatus, in one embodiment, includes a processor and a memory that stores code executable by the processor. In certain embodiments, the code is executable by the processor to transmit a charging signal and receive a respective response signal from each of a plurality of tag devices responsive to the charging signal in which each respective response signal includes first configuration data for a particular first device associated with each respective tag device for determining compatibility between each first device and a second device.

One embodiment of a method that can determine device compatibility using tag devices includes a processor transmitting a charging signal. In some embodiments, the method further includes the processor receiving a respective response signal from each of a plurality of tag devices responsive to the charging signal in which each respective response signal includes first configuration data for a particular first device associated with each respective tag device for determining compatibility between each first device and a second device.

A computer program product that can determine device compatibility using tag devices includes a computer-readable storage medium including program instructions embodied therewith. In certain embodiments, the program instructions are executable by a processor to cause the processor to transmit a charging signal and receive a respective response signal from each of a plurality of tag devices responsive to the charging signal in which each respective response signal includes first configuration data for a particular first device associated with each respective tag device for determining compatibility between each first device and a second device.

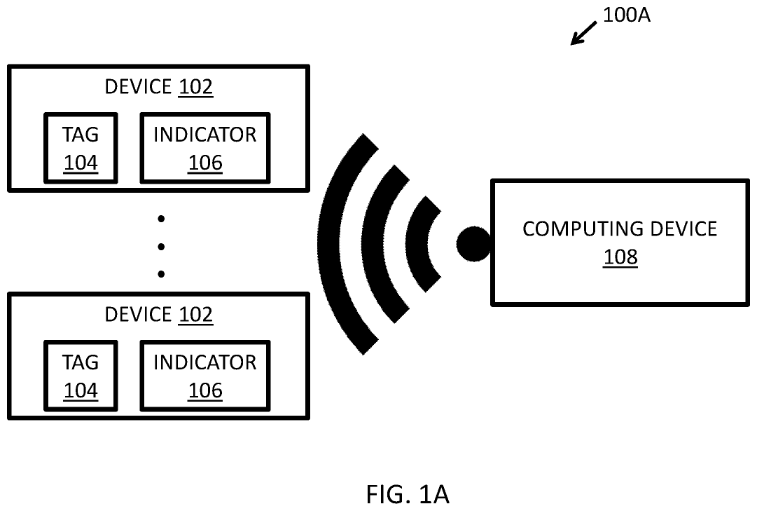

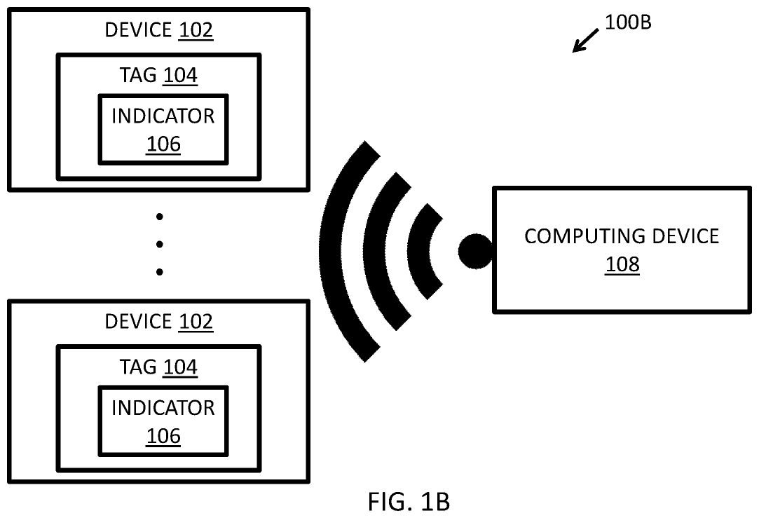

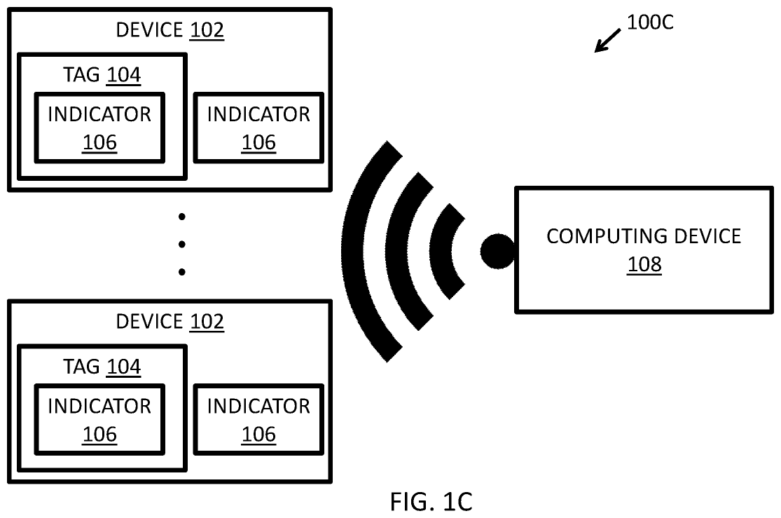

Turning now to the drawings, FIGS. 1A through 1C are block diagrams of various embodiments of a computing system 100A, a computing system 100B, and a computing system 100C, respectively, that each use tag devices to determine compatibility between devices. As discussed herein, the computing systems 100A, 100B, and 100C may simply be referred to individually or collectively as, computing system(s) 100.

At least in the embodiment illustrated in FIG. 1A, a computing system 100A includes, among other components and/or features, a set of devices 102 and a computing device 108. In the illustrated embodiment, the computing device 108 includes a tag device 104 and an indicator 106. As referred to herein, the devices 102 may be referenced individually or collectively as, device(s) 102.

A computing system 100B, at least in the embodiment illustrated in FIG. 1B, includes among other components and/or features, a set of devices 102 and a computing device 108. In the illustrated embodiment, each device 102 includes a tag device 104 and each tag device 104 includes an indicator 106. One difference between computing system 100A and computing system 100B is that each of the tag devices 104 in the computing system 100B includes an indicator 106, whereas each device 102 in the computing system 100A includes the indicator 106.

At least in the embodiment illustrated in FIG. 1C, a computing system 100C includes, among other components and/or features, a set of devices 102 and a computing device 108. In the illustrated embodiment, the computing device 108 includes a tag device 104 and an indicator 106 and the tag devices 104 in the computing system 100C also include an indicator 106.

A set of devices 102 may include any suitable quantity of computing devices 102. That is, while the illustrated embodiments of the computing systems 100A and 100B are shown as including two (2) devices 102, various other embodiments of the computing systems 100A and/or 100B may include one (1) device 102 or a quantity of devices 102 greater than two devices 102 (e.g., three (3) or more devices 102).

A device 102 may include any suitable type of device and/or particular device that is known or developed in the future. In various embodiments, a device 102 includes and/or forms at least a portion of a peripheral device for a computing device 104.

A peripheral device may include any suitable type of peripheral device and/or particular peripheral device that is known or developed in the future. Examples of a peripheral device can include, but are not limited to, a charging device (e.g., charger, a set of one or more batteries, etc.), a set of one or more audio devices (e.g., one or more speakers, one or more headphones, one or more earbuds, etc.), a display device (e.g., a display screen, a monitor, a touchscreen, virtual reality (VR) glasses, VR goggles, augmented reality (AR) glasses, AR goggles, a head mounted display (HMD), etc.), a printer, an input device (e.g., a keyboard, a mouse, a touchpad, a trackball, a joystick, a light pen, a stylus, a microphone, etc.), a camera, and/or a memory device (e.g., a flash drive, a thumb drive, external hard drive, etc.), etc., among other peripheral devices that are possible and contemplated herein.

In the embodiment of a computing system 100A illustrated in FIG. 1A, one or more devices 102 include, among other components, a tag device 104 and an indicator 106 (e.g., a compatibility indicator 106). Each tag device 104, indicator 106, and their associated device 102 operate in conjunction with one another and/or in conjunction with the computing device 108 to determine and/or facilitate determining the compatibility of the device(s) 102 and the computing device 108.

In at least some embodiments, the compatibility of the device(s) 102 and the computing device 108 includes determining whether one or more devices 102 (e.g., a device 102, each device 102, or a subset of devices 102 (e.g., two or more devices 102)) is/are compatible with the computing device 108. In additional or alternative embodiments, the compatibility of the device(s) 102 and the computing device 108 can include determining the level and/or degree with which the one or more devices 102 is/are compatible with the computing device 108.

In various embodiments, compatibility can mean, but is not limited to, the ability of a device 102 and a computing device 108 to operate and/or function in conjunction with one another. That is, the ability of a device 102 to operate and/or perform one or more of its intended functions in conjunction with the computing device 108 and/or for the computing device 108, and/or the ability of a computing device 108 to operate and/or perform one or more of its intended functions in conjunction with the device 102 and/or for the device 102.

A tag device 104 may include any suitable tag and/or type of tag that is known or developed in the future capable of performing the operations and/or functions of a tag device 104 discussed herein. A tag device 104, in various embodiments, may be coupled to and/or attached (e.g., directly or indirectly) to its associated device 102 or may be positioned and/or located proximate to its associated device 102 and/or a representation of its associated device 102.

In various embodiments, the tag device 104 is configured to store configuration data about a device 102 associated with the tag device 104. The configuration data stored in a tag device 104 may include any suitable configuration data that is known or developed in the future capable of describing one or more features, attributes, and/or characteristics, etc. of a particular device 102, identifying the particular device 102, and/or identifying the type of device 102 that the tag device 104 is associated.

The configuration data, in various embodiments, is used as a basis for determining the compatibility of a device 102 and a computing device 108. For example, the configuration data stored in the tag device 104 can identify a type, make, model, year, one or more features, and/or one or more characteristics of its associated device 102, among other data capable of being used to identify and/or determine compatibility between a device 102 and a computing device 108 that is/are possible and contemplated herein, and the computing device 108 can utilize the configuration data to determine whether the device 102 is compatible with the computing device 108 and/or the level/degree to which the device 102 is compatible with the computing device 108.

In certain embodiments, a tag device 104 includes a radio frequency identifier (RFID) tag device 104 (e.g., an RFID tag). In other embodiments, a tag device 104 includes a Bluetooth® tag device 104 (e.g., a Bluetooth® tag). As disclosed herein, various embodiments of a computing system 100A, a computing system 100B, and/or a computing system 100C can include all RFID tag devices 104, all Bluetooth® tag devices 104, or at least one RFID tag device 104 and at least one Bluetooth® tag device 104.

In various embodiments, a tag device 104 includes a passive tag. That is, an RFID tag, in some embodiments, can include a passive RFID tag device 104 and/or a Bluetooth® tag, in certain embodiments, can include a passive Bluetooth® tag device 104, among other passive tags that are possible and contemplated herein.

In certain embodiments, a passive tag device 104 is configured to be charged via a charging signal received from a computing device 108 (e.g., an RFID charging signal, a Bluetooth® charging signal, etc.). Further, in response to being charged, a passive tag device 104 is configured transmit and/or provide the configuration data about its associated device 102 to the computing device 108 that provided and/or transmitted the charging signal.

In various embodiments, a tag device 104 is configured to actuate and/or activate an indicator 106 in response to receiving a signal (e.g., an actuation signal) from a computing device 108. An activated and/or actuated indicator 106 can provide a representation and/or an indication to a user that a device 102 is compatible or non-compatible with a computing device 108.

In additional or alternative embodiments, the signal received from the computing device 108 causes the tag device 104 to actuate and/or activate one of a plurality of different indication types and/or one of a plurality of different compatibility levels of an indicator 106 depending on the degree with which its associated device 102 is compatible with the computing device 108. Here, different activated and/or actuated indication types and/or levels on an indicator 106 can provide a representation and/or an indication to a user the level and/or degree with which a device 102 is compatible (or non-compatible) with a computing device 108.

In some embodiments (e.g., computing system 100A and/or computing system 100C), the tag device 104 and/or the device 102 is configured to actuate and/or activate an indicator 106 on the device 102. In other embodiments, (e.g., computing system 100B and/or computing system 100C), the tag device 104 and/or the device 102 is configured to actuate and/or activate an indicator 106 on the tag device 104. In further embodiments (e.g., computing system 100C), the tag device 104 and/or the device 102 is configured to actuate and/or activate an indicator 106 on the device 102, the tag device 104 and/or the device 102 is configured to actuate and/or activate an indicator 106 on the tag device 104, the tag device 104 is configured to actuate and/or activate an indicator 106 on the tag device 104 and the device 102 is configured to actuate and/or activate an indicator 106 on the device 102, or the tag device 104 is configured to actuate and/or activate an indicator 106 on the device 102 and the device 102 is configured to actuate and/or activate an indicator 106 on the tag device 104, among other combinations that are possible and contemplated herein.

An indicator 106 may include any suitable device that is known or developed in the future capable of providing a cue, characteristic, trait, and/or a change to a characteristic and/or trait that can be sensed by a user (e.g., a human, a computing device, etc.). An indicator 106 may be actuated and/or activated by a tag device 104 and/or a device 102 in response to receiving a signal from a computing device 108.

In certain embodiments, different indication types and/or different indication levels of an indicator 106 may be actuated and/or activated by the tag device 104 and/or device 102 depending on the degree with which the device 102 is compatible with a computing device 108, as discussed in greater detail elsewhere herein. An indicator 106, in various embodiments, may include one or more visual indicators, one or more auditory indicators, and/or one or more tactile indicators, among other indicators that are possible and contemplated herein.

A visual indicator 106 may include any suitable visual indication and/or cue that is known or developed in the future. In certain embodiments, the visual indicator 106 includes one or more lights (e.g., a light-emitting diode (LED), etc.), among other visual indicators that are possible and contemplated herein. For example, a light being turned ON or remaining ON can indicate that a device 102 is compatible with a computing device 108 and a light remaining OFF or being turned OFF can indicate that the device 102 is not compatible with the computing device 108 or vice versa, among other examples that are possible and contemplated herein.

In various embodiments, the visual indicator 106 can provide multiple visual indications representing different levels of compatibility. In certain embodiments, the visual indicator 106 can include two or more different colors, two or more different patterns (e.g., two or more blinking rates, two or more flashing rates, a blinking pattern and a flashing pattern, a solid light and a blinking/flashing light, etc.), two or more different intensities, and/or two or more different locations/positions, etc., among different visual indicators that are possible and contemplated herein. Here, the different colors, patterns, intensities, and/or locations, etc. may be selected based on the degree with which a device 102 is compatible with a computing device 108.

The degree with which a device 102 and a computing device 108 are compatible may include any suitable comparison, ratio, and/or amount of compatibility, etc. that is/are known, determinable, discoverable, and/or developed in the future. For example, a device 102 and a computing device 108 may be totally/completely compatible, highly compatible, moderately compatible, slightly compatible, or non-compatible, among other degrees, comparisons, ratios, and/or amounts of compatibility and/or quantities of degrees, comparisons, ratios, and/or amounts of compatibility, etc. that are possible and contemplated herein. In another non-limiting example, a device 102 and a computing device 108 may be optimally compatible, functionally compatible (e.g., compatible, but less than optimally compatible), incompatible (e.g., compatible, but less than a predetermined threshold or level of compatibility), or non-compatible, etc., among other categories and/or classifications of compatibility and/or quantities of categories and/or classifications of compatibility that are possible and contemplated herein.

In one non-limiting example, a solid light can indicate that a device 102 is totally/completely compatible with a computing device 108 and a blinking/flashing light can indicate that the device 102 is highly or moderately compatible (e.g., less than totally/completely compatible) with the computing device 108 or vice versa. In another non-limiting example, a blinking light can indicate that a device 102 is moderately compatible with a computing device 108 and a flashing light can indicate that the device 102 is slightly compatible with the computing device 108 or vice versa. In still another non-limiting example, a rapidly blinking light can indicate that a device 102 is highly compatible with a computing device 108 and a slowly blinking light can indicate that the device 102 is slightly compatible with the computing device 108 or vice versa. In yet another non-limiting example, a bright light can indicate that a device 102 is totally compatible with a computing device 108, a moderate intensely lit light can indicate that the device 102 is moderately compatible with the computing device 108, and a dimly lit light can indicate that the device 102 is slightly compatible with the computing device 108 or any combination thereof. In a further non-limiting example, a green light can indicate that a device 102 is totally compatible with a computing device 108, a yellow light can indicate that the device 102 is moderately compatible with the computing device 108, and a red light can indicate that the device 102 is not compatible with the computing device 108 or any combination thereof. In still a further non-limiting example, actuation/activation of different lights oriented at different positions/locations can indicate different degrees and/or levels of compatibility between a device 102 and a computing device 108.

In certain more specific non-limiting examples, a 0.5 A 5V charger (e.g., a first device 102) may be considered and/or deemed to be functionally compatible with a laptop computer (e.g., computing device 108) and a 2 A 12V charger (e.g., a second device 102) may be considered and/or deemed to be optimally compatible with the laptop computer. Here, an indicator light 106 on the first device 102 (e.g., computing system 100A and/or computing system 100C) and/or on the tag device 104 (e.g., computing system 100B and/or computing system 100C) associated with the first device 102 may be actuated/activated to present/display a yellow light indicating to the user that the 0.5 A 5V charger is functionally compatible with the laptop computer and the indicator light 106 on the second device 102 and/or on the tag device 104 associated with the second device 102 may be actuated/activated to present/display a green light indicating to the user that the 2 A 12V charger is optimally compatible with the laptop computer, among other possibilities that ae possible and contemplated herein.

While the above examples provide various details and/or specifics, the various embodiments disclosed herein are not limited to the above examples, details, and/or specifics. That is, various other embodiments may include any other suitable specifics, details, characteristics, and/or traits consistent with the various examples and/or specifics discussed above. In other words, various other embodiments that are not specifically disclosed and/or described herein, but that are possible based on an application of the concepts, description, and/or details provided herein, are each contemplated and included within the spirit and scope of this disclosure.

An auditory indicator 106 may include any suitable audible indicator and/or cue that is known or developed in the future. In various embodiments, the auditory indicator 106 includes a sound and/or noise, among other audible indicators that are possible and contemplated herein. For example, a sound/noise being turned ON or remaining ON can indicate that a device 102 is compatible with a computing device 108 and a sound/noise remaining OFF or being turned OFF can indicate that the device 102 is not compatible with the computing device 108 or vice versa.

In various embodiments, the auditory indicator 106 can provide multiple audible indications and/or cues representing different levels of compatibility. In certain embodiments, the auditory indicator 106 can include two or more different sounds/tones, two or more different patterns (e.g., two or more rates (e.g., beeps, buzzes, etc.)), two or more tone lengths, a solid tone and a beeping tone, etc.), and/or two or more different frequencies, etc., among different audible indicators that are possible and contemplated herein. Here, the different sounds, patterns, lengths, and/or frequencies may be selected based on the degree with which a device 102 is compatible with a computing device 108 similar to the visual indications discussed above.

A tactile indicator 106 may include any suitable tactile indicator and/or cue that is known or developed in the future. In various embodiments, the tactile indicator 106 includes a vibration, among other tactile indicators that are possible and contemplated herein. For example, a vibration being turned ON or remaining ON can indicate that a device 102 is compatible with a computing device 108 and a vibration remaining OFF or being turned OFF can indicate that the device 102 is not compatible with the computing device 108 or vice versa.

In various embodiments, the tactile indicator 106 can provide multiple tactile indications and/or cues representing different levels of compatibility. In certain embodiments, the tactile indicator 106 can include two or more different tactile sensations, two or more different patterns (e.g., two or more different vibrations), two or more vibration lengths, and/or two or more different intensities, etc., among different tactile indicators that are possible and contemplated herein. Here, the different tactile sensations, patterns, lengths, and/or intensities may be selected based on the degree with which a device 102 is compatible with a computing device 108 similar to the visual indications discussed above.

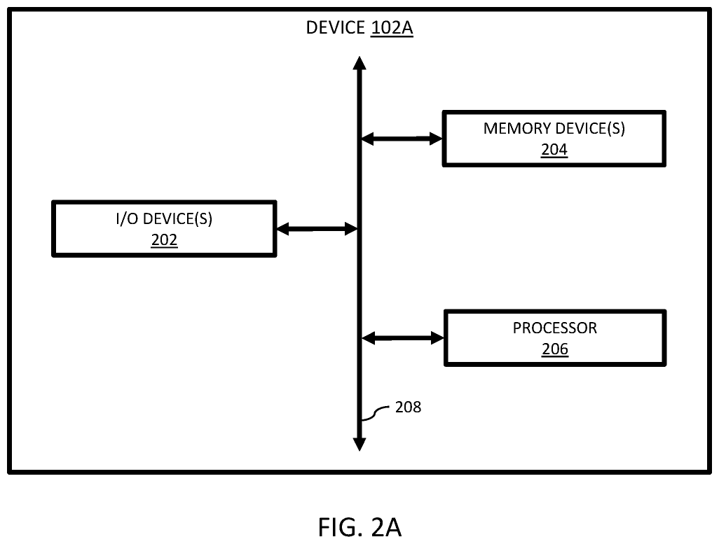

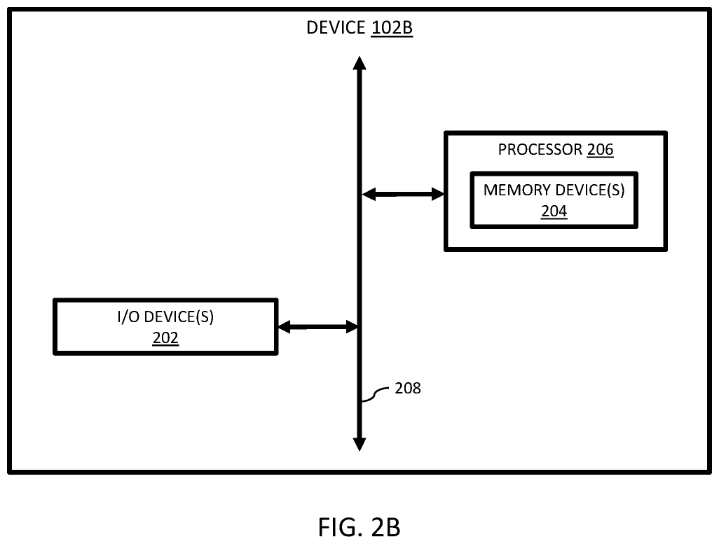

With reference to FIG. 2A, FIG. 2A is a block diagram of one embodiment of a device 102A (e.g., an embodiment including a processing device). At least in the embodiment illustrated in FIG. 2A, a device 102A includes, among other components and/or features, a set of input/output (I/O) devices 202, a set of memory devices 204, and a processor 206 coupled to and/or in communication with one another via a bus 208 (e.g., a wired and/or wireless bus).

A set of I/O devices 202 may include an any suitable quantity of I/O devices 202. Further, the I/O device(s) 202 may include any suitable I/O device that is known or developed in the future. In various embodiments, the I/O device(s) 202 is/are configured to enable the device 102A to communicate (e.g., transmit and/or receive signals) with a tag device 104, an indicator 106, and/or a computing device 108.

A set of memory devices 204 may include any suitable quantity of memory devices 204. Further, a memory device 204 may include any suitable type of device and/or system that is known or developed in the future that can store computer-useable code and/or computer-readable code. In various embodiments, a memory device 204 may include one or more non-transitory computer-usable mediums (e.g., readable, writable, readable-writable, etc.), which may include any non-transitory and/or persistent apparatus or device that can contain, store, communicate, propagate, and/or transport applications, instructions, data, computer programs, software, code, routines, etc., for processing by or in connection with a computer processing device (e.g., processor 206).

A memory device 204, in some embodiments, includes volatile computer storage media. For example, a memory device 204 may include random access memory (RAM), including dynamic RAM (DRAM), synchronous dynamic RAM (SDRAM), and/or static RAM (SRAM). In other embodiments, a memory device 204 includes non-volatile computer storage media. For example, a memory device 204 may include flash memory and/or any other suitable non-volatile computer storage device that is known or developed in the future. In various embodiments, a memory device 204 includes both volatile and non-volatile computer storage media.

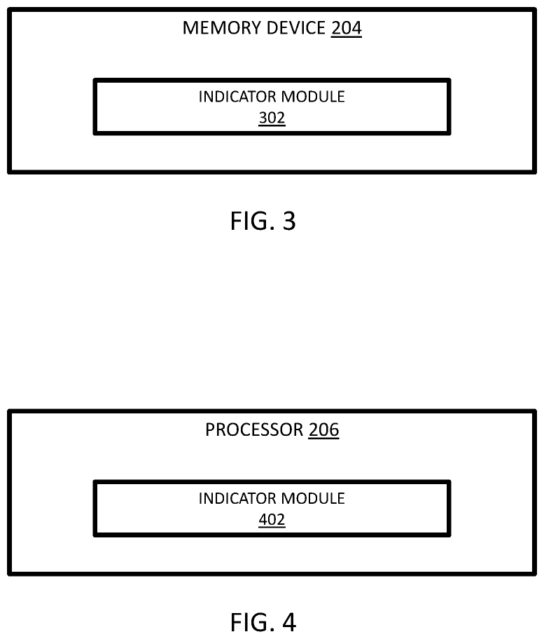

With reference to FIG. 3, FIG. 3 is a block diagram of one embodiment of a memory device 204. At least in the embodiment illustrated in FIG. 3, a memory device 204 includes, among other components and/or features, an indicator module 302 configured to operate/function when executed by a processor 206.

An indicator module 302 may include any suitable hardware and/or software that is known or developed in the future that can actuate one or more indicators 106. The indicator module 302 may actuate and/or activate the indicator(s) 106 using any suitable technology, process, method, and/or technique that is known or developed in the future.

In various embodiments, the indicator module 302 is configured to receive a signal (e.g., an actuation signal) from a computing device 108 (e.g., via the I/O device(s) 202). In some embodiments, the signal received from the computing device 108 can instruct and/or command the indicator module 302 to actuate and/or activate one or more indicators 106 representing the compatibility and/or non-compatibility of the device 102A and the computing device 108. In additional or alternative embodiments, the signal received from the computing device 108 can instruct and/or command the indicator module 302 to actuate and/or activate one or more indicators 106 to include one or more characteristics and/or traits representing the level and/or degree of compatibility and/or non-compatibility of the device 102A and the computing device 108.

The indicator module 302, in various embodiments, is configured to actuate and/or activate one or more indicators 106 consistent with the instruction(s) and/or command(s) in the signal received from the computing device 108. That is, the indicator module 302 is configured to actuate and/or activate one or more indicators 106 representing the compatibility and/or non-compatibility of the device 102A and the computing device 108 in response to receiving the signal from the computing device 108.

In some embodiments, the indicator module 302 is configured to actuate and/or activate an indicator 106 on the device 102A (see, e.g., computing system 100A and/or computing system 100C) in response to receiving the signal from the computing device 108. In additional or alternative embodiments, the indicator module 302 is configured to actuate and/or activate an indicator 106 on the tag device 104 (see, e.g., computing system 100B and/or computing system 100C) in response to receiving the signal from the computing device 108.

The indicator module 302, in various additional or alternative embodiments, is configured to actuate and/or activate one or more of a plurality of different characteristics and/or traits on one or more indicators 106 consistent with the instruction(s) and/or command(s) in the signal received from the computing device 108. That is, the indicator module 302 is configured to actuate and/or activate the characteristic(s) and/or trait(s) on one or more indicators 106 representing the level and/or degree of compatibility and/or non-compatibility of the device 102A and the computing device 108 in response to receiving the signal from the computing device 108.

In some embodiments, the indicator module 302 is configured to actuate and/or activate one or more characteristics and/or traits of an indicator 106 on the device 102A (see, e.g., computing system 100A and/or computing system 100C) in response to receiving the signal from the computing device 108. In additional or alternative embodiments, the indicator module 302 is configured to actuate and/or activate one or more characteristics and/or traits an indicator 106 on the tag device 104 (see, e.g., computing system 100B and/or computing system 100C) in response to receiving the signal from the computing device 108.

Referring back to FIG. 2A, a processor 206 may include any suitable non-volatile/persistent hardware and/or software configured to perform and/or facilitate performing functions and/or operations for determining device compatibility using tag devices 104. In various embodiments, the processor 206 includes hardware and/or software for executing instructions in one or more modules and/or applications that can perform and/or facilitate performing functions and/or operations for determining device compatibility using tag devices 104. The modules and/or applications executed by the processor 206 for determining device compatibility using tag devices 104 can be stored on and executed from a memory device 204 and/or from the processor 206.

With reference to FIG. 4, FIG. 4 is a schematic block diagram of one embodiment of a processor 206. At least in the illustrated embodiment, the processor 206 includes, among other components and/or features, an indicator module 402 similar to the indicator module 302 in the memory device 204 discussed with reference to FIG. 3.

Referring to FIG. 2B, FIG. 2B is a block diagram of another embodiment of a device 102B (e.g., another embodiment including a processing device). At least in the illustrated embodiment, the device 102B includes, among other components and/or features, a set of I/O devices 202, a set of memory devices 204, a processor 206, and a bus 208 similar to the I/O device(s) 202, memory device(s) 204, processor 206 and bus 208 included in the device 102A illustrated in FIG. 2A. A difference between the device 102B and the device 102A is that the memory device(s) 204 of the device 102B are included in and/or form a portion of the processor 206, whereas the memory device(s) 204 of the device 102A is/are separate from and/or are device(s) that is/are independent from the processor 206.

With reference again to FIGS. 1A through 1C, a device 102, in additional or alternative embodiments, can include an accessory for a computing device 108. An accessory may include any suitable type of accessory and/or particular accessory that is known or developed in the future. Examples of an accessory include, but are not limited to, a case (e.g., cellphone case, a laptop case, etc.) and a screen protector, etc., among other accessories that are possible and contemplated herein.

In some embodiments, (e.g., embodiments in which the device 102 includes an accessory, includes a non-electronic device, and/or includes a processing device, etc.), the tag device 104 is configured to receive the signal (e.g., the actuation signal) from the computing device 108 and actuate and/or activate the indicator 106 on the device 102 and/or the indicator 106 on the tag device 104 consistent with the signal received from the computing device 108. That is, the signal received from the computing device 108 can instruct and/or command the tag device 104 to actuate and/or activate one or more indicators 106 representing the compatibility and/or non-compatibility of the device 102 and the computing device 108. In additional or alternative embodiments, the signal received from the computing device 108 can instruct and/or command the tag device 104 to actuate and/or activate one or more indicators 106 to include one or more characteristics and/or traits representing the level and/or degree of compatibility and/or non-compatibility of the device 102 and the computing device 108.

Further, the tag device 104, in various embodiments, is configured to actuate and/or activate one or more indicators 106 consistent with the instruction(s) and/or command(s) in the signal received from the computing device 108. That is, the tag device 104 is configured to actuate and/or activate one or more indicators 106 representing the compatibility and/or non-compatibility of the device 102 and the computing device 108 in response to receiving the signal from the computing device 108.

In some embodiments, the tag device 104 is configured to actuate and/or activate an indicator 106 on the device 102 (see, e.g., computing system 100A and/or computing system 100C) in response to receiving the signal from the computing device 108. In additional or alternative embodiments, the tag device 104 is configured to actuate and/or activate an indicator 106 on the tag device 104 (see, e.g., computing system 100B and/or computing system 100C) in response to receiving the signal from the computing device 108.

The tag device 104, in various additional or alternative embodiments, is configured to actuate and/or activate one or more of a plurality of different characteristics and/or traits on one or more indicators 106 consistent with the instruction(s) and/or command(s) in the signal received from the computing device 108. That is, the tag device 104 is configured to actuate and/or activate the characteristic(s) and/or trait(s) on one or more indicators 106 representing the level and/or degree of compatibility and/or non-compatibility of the device 102 and the computing device 108 in response to receiving the signal from the computing device 108.

In some embodiments, the tag device 104 is configured to actuate and/or activate one or more characteristics and/or traits of an indicator 106 on the device 102 (see, e.g., computing system 100A and/or computing system 100C) in response to receiving the signal from the computing device 108. In additional or alternative embodiments, the tag device 104 is configured to actuate and/or activate one or more characteristics and/or traits an indicator 106 on the tag device 104 (see, e.g., computing system 100B and/or computing system 100C) in response to receiving the signal from the computing device 108.

A computing device 108 may include any suitable computing system and/or computing device capable of accessing and/or communicating with a device 102 and/or a tag device 104 via a wireless signal (e.g., an RFID signal, a Bluetooth® signal, etc.). In various embodiments, the computing device 108 includes a mobile computing device 108. Examples of a computing device 108 include, but are not limited to, a laptop computer, a personal digital assistant (PDA), a tablet computer, a smart phone, a cellular telephone, a wearable device, an Internet of Things (IoT) device, a gaming device, a vehicle on-board computer, a smart device, and a digital assistant, etc., among other computing devices that are possible and contemplated herein.

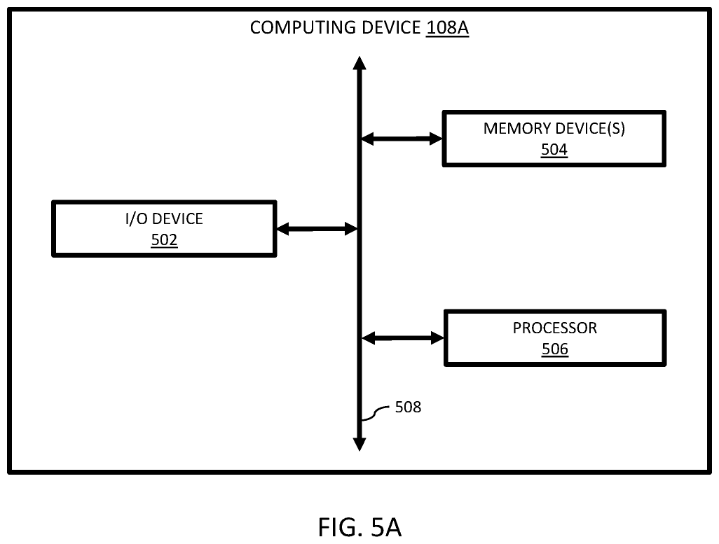

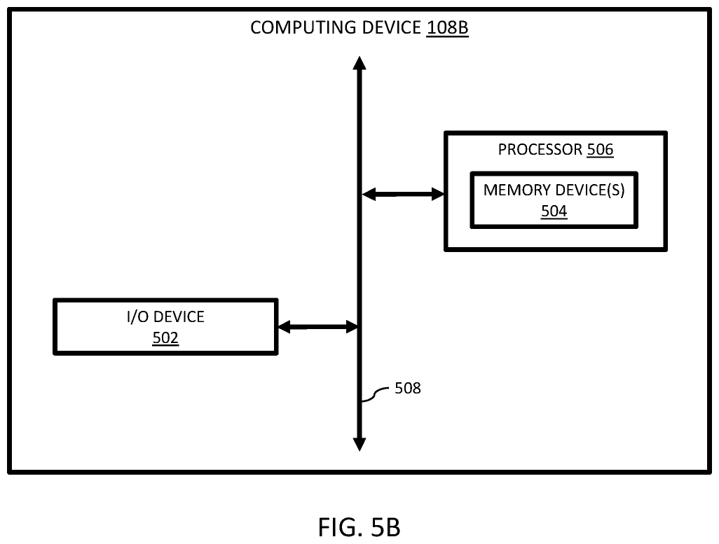

With reference to FIG. 5A, FIG. 5A is a block diagram of one embodiment of a computing device 108A. At least in the embodiment illustrated in FIG. 5A, a computing device 108A includes, among other components and/or features, a set of input/output (I/O) devices 502, a set of memory devices 504, and a processor 506 coupled to and/or in communication with one another via a bus 508 (e.g., a wired and/or wireless bus).

A set of I/O devices 502 may include an any suitable quantity of I/O devices 202. Further, the I/O device(s) 502 may include any suitable I/O device that is known or developed in the future. In various embodiments, the I/O device(s) 502 is/are configured to enable the computing device 108A to communicate (e.g., transmit and/or receive signals (e.g., RFID signals and/or Bluetooth® signals, etc.) with one or more devices 102 and/or one or more tag devices 104. Further, the I/O device(s) 502 is/are configured to enable the computing device 108A to at least receive inputs from a user.

A set of memory devices 504 may include any suitable quantity of memory devices 504. Further, a memory device 504 may include any suitable type of device and/or system that is known or developed in the future that can store computer-useable code and/or computer-readable code. In various embodiments, a memory device 504 may include one or more non-transitory computer-usable mediums (e.g., readable, writable, readable-writable, etc.), which may include any non-transitory and/or persistent apparatus or device that can contain, store, communicate, propagate, and/or transport applications, instructions, data, computer programs, software, code, routines, etc., for processing by or in connection with a computer processing device (e.g., processor 506).

A memory device 504, in some embodiments, includes volatile computer storage media. For example, a memory device 504 may include RAM, including DRAM, SDRAM, and/or SRAM. In other embodiments, a memory device 504 includes non-volatile computer storage media. For example, a memory device 504 may include flash memory and/or any other suitable non-volatile computer storage device that is known or developed in the future. In various embodiments, a memory device 504 includes both volatile and non-volatile computer storage media.

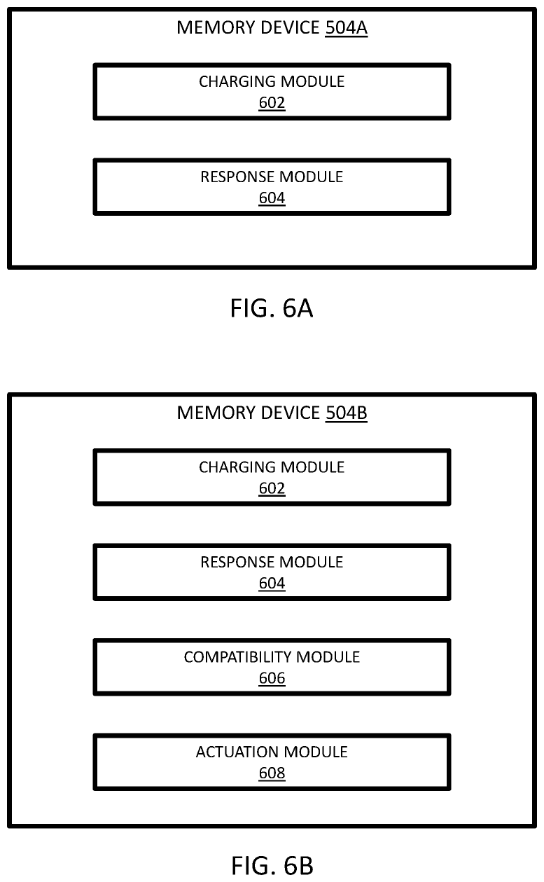

With reference to FIG. 6A, FIG. 6A is a block diagram of one embodiment of a memory device 504A. At least in the embodiment illustrated in FIG. 6A, a memory device 504A includes, among other components and/or features, a charging module 602 and a response module 604 configured to operate/function with one another to determine and/or facilitate determining device compatibility when executed by a processor 506.

A charging module 602 may include any suitable hardware and/or software that is known or developed in the future that can charge one or more tag devices 104. The charging module 602 may charge the tag device(s) 104 using any suitable technology, process, method, and/or technique that is known or developed in the future.

In various embodiments, the charging module 602 is configured to generate a charging signal. The charging signal may include any suitable signal that is known or developed in the future capable of charging a tag device 104 (e.g., a passive tag device 104). In certain embodiments, the charging signal includes an RFID charging signal that can charge and/or energize a passive RFID tag device 104. In additional or alternative embodiments, the charging signal includes a Bluetooth® charging signal that can charge and/or energize a passive Bluetooth® tag device 104.

The charging module 602, in various embodiments, is configured to transmit and/or broadcast the generated charging signal to one or more tag devices 104 (e.g., passive tag devices 104). In some embodiments, the charging module 602 is configured to transmit and/or broadcast the generated charging signal to one or more targeted tag devices 104. In additional or alternative embodiments, the charging module 602 is configured to transmit and/or broadcast the generated charging signal to a target area that may include one or more targeted tag devices 104 and/or one or more tag devices 104 in general. In further additional or alternative embodiments, the charging module 602 is configured to transmit and/or broadcast the generated charging signal to a general area that may include one or more targeted tag devices 104 and/or one or more tag devices 104 in general.

In some embodiments, the charging module 602 is configured to transmit and/or broadcast the generated charging signal in response to receiving a user input and/or command to transmit and/or broadcast the generated charging signal. In additional or alternative embodiments, the charging module 602 is configured to transmit and/or broadcast the generated charging signal in response to detecting and/or identifying one or more trigger conditions, one or more trigger events, and/or one or more trigger locations, which can include any suitable condition(s), event(s), and/or one or more location(s) that can trigger a desire to determine and/or identify one or more compatible devices 102.

A response module 604 may include any suitable hardware and/or software that can receive one or more response signals from one or more tag devices 104. In various embodiments, a response signal received from a tag device 104 includes configuration data.

As discussed elsewhere herein, the configuration data received from a particular tag device 104 includes the configuration data for the device 102 associated with the particular tag device 104. The configuration data can be used by a computing device 108 to determine whether the device 102 associated with the particular tag device 104 is compatible with the computing device 108 and may further be used by the computing device 108 to determine the level and/or degree with which the device 102 associated with the particular tag device 104 is compatible with the computing device 108.

Referring to FIG. 6B, FIG. 6B is a block diagram of another embodiment of a memory device 504B. A memory device 504B includes a charging module 602 and a response module 604 similar to the charging module and response module 604 included in the memory device 504A discussed with reference to FIG. 6A. At least in the embodiment illustrated in FIG. 6B, the memory device 504B further includes, among other components and/or features, a compatibility module 606 and an actuation module 608 configured to operate/function with one another and with the charging module and response module 604 to determine and/or facilitate determining device compatibility when executed by a processor 506.

A compatibility module 606 may include any suitable hardware and/or software that can determine compatibility between a computing device 108 and one or more devices 102. Compatibility can be determined using any suitable technology, process, method, and/or technique that is known or developed in the future.

In various embodiments, the compatibility module 606 is configured to receive configuration data for one or more devices 102. Further, the compatibility module 606 is configured to determine compatibility of the computing device 108 and each of one or more devices 102 based on the configuration data for each respective device 102. In additional embodiments, the compatibility module 606 is configured to determine the level and/or degree of compatibility of the computing device 108 and each of one or more devices 102 based on the configuration data for each respective device 102.

In certain embodiments, the compatibility module 606 is configured to store configuration data for the computing device 108. At least a portion of the configuration data for the computing device 108 corresponds to and/or is analogous to one or more portions of the configuration data for the device(s) 104.

The compatibility module 606, in various embodiments, is configured to compare the configuration data for the computing device 108 and the configuration data for a particular device 104 and/or each device 104 to determine a match. A match can form the basis for determining compatibility and can include one or more a type, make, model, year, one or more features, and/or one or more characteristics of the computing device 108 matching the type, make, model, year, feature(s), and/or characteristic(s) of a device 102. A non-match can form the basis for determining non-compatibility and can include one or more (or all) of the type, make, model, year, one or more features, and/or one or more characteristics of the computing device 108 not matching one or more (or all) of the type, make, model, year, feature(s), and/or characteristic(s) of a device 102.

The compatibility module 606, in additional embodiments, is configured to compare the configuration data for the computing device 108 and the configuration data for a particular device 104 and/or each device 104 to determine the level and/or degree with which the computing device 108 and a device 102 are compatible. Matching one or more (or all) of a type, make, model, year, one or more features, and/or one or more characteristics of the computing device 108 and one or more (or all) of the type, make, model, year, feature(s), and/or characteristic(s) of a device 102 can form the basis of to what level/degree the computing device 108 matches or does not match a particular device 102.

The level/degree with which the computing device 108 and a particular device 102 match can be based on any suitable factor(s) and/or relationship(s) between the type, make, model, year, one or more features, and/or one or more characteristics of the computing device 108 and the type, make, model, year, feature(s), and/or characteristic(s) of a device 102. For example, the type, make, model, year, one or more features, and/or one or more characteristics of the computing device 108 matching the type, make, model, year, feature(s), and/or characteristic(s) of a device 102 can be considered complete/total compatibility between the computing device 108 and a particular device 102. Further, a predetermined and/or predefined quantity and/or subset of the type, make, model, year, one or more features, and/or one or more characteristics of the computing device 108 matching the device 102 can be considered functional compatibility between the computing device 108 and a particular device 102. Less than the predetermined and/or predefined quantity and/or subset of the type, make, model, year, one or more features, and/or one or more characteristics of the computing device 108 matching the device 102 can be considered incompatibility between the computing device 108 and a particular device 102. In addition, none of the type, make, model, year, one or more features, and/or one or more characteristics of the computing device 108 matching the device 102 can be considered non-compatibility between the computing device 108 and a particular device 102.

While the above examples of levels and/or degrees of compatibility provide various details and/or specifics, the various embodiments disclosed herein are not limited to the above examples, details, and/or specifics. That is, various other embodiments may include any other suitable specifics, details, characteristics, and/or traits consistent with the various examples and/or specifics discussed above. In other words, various other embodiments that are not specifically disclosed and/or described herein, but that are possible based on an application of the concepts, description, and/or details provided herein, are each contemplated and included within the spirit and scope of the possible levels and/or degrees of compatibility and are included as part of this disclosure.

The compatibility module 606, in various embodiments, is configured to transmit an indication of the determined compatibility between the computing device 108 and each of one or more particular devices 102 to the actuation module 608. In additional embodiments, the compatibility indication transmitted to the actuation module 608 can further include the level and/or degree of compatibility between the computing device 108 and each of one or more particular devices 102. In various embodiments, the actuation module 608 is configured to receive the indication of compatibility between the computing device 108 and each of one or more particular devices 102 from the compatibility module 606.

An actuation module 608 may include any suitable hardware and/or software capable of transmitting one or more actuation signals. In some embodiments, the actuation module 608 is configured to transmit an actuation signal to each of one or more compatible devices 102. In additional or alternative embodiments, the actuation module 608 is configured to transmit an actuation signal to each of one or more tag devices 104 associated with a compatible device 102.

In various embodiments, the actuation signal instructs and/or commands a device 102 and/or an indicator module 302 to actuate and/or activate one or more indicators 106 representing the compatibility and/or non-compatibility of the device 102 and the computing device 108. In additional or alternative embodiments, the actuation signal instructs and/or commands the device 102 and/or indicator module 302 to actuate and/or activate one or more indicators 106 to include one or more characteristics and/or traits representing the level and/or degree of compatibility and/or non-compatibility of the device 102 and the computing device 108.

The actuation signal instructs and/or commands the device 102 and/or indicator module 302 to actuate and/or activate one or more indicators 106 consistent with the instruction(s) and/or command(s) in the actuation signal. That is, the actuation signal instructs and/or commands the device 102 and/or indicator module 302 to actuate and/or activate one or more indicators 106 representing the compatibility and/or non-compatibility of the device 102 and the computing device 108.

In some embodiments, the actuation signal instructs and/or commands the device 102 and/or indicator module 302 to actuate and/or activate an indicator 106 on the device 102 (see, e.g., computing system 100A and/or computing system 100C) in response to receiving the actuation signal. In additional or alternative embodiments, the actuation signal instructs and/or commands the device 102 and/or indicator module 302 to actuate and/or activate an indicator 106 on the tag device 104 (see, e.g., computing system 100B and/or computing system 100C) in response to receiving the signal from the computing device 108.

In additional or alternative embodiments, the actuation signal instructs and/or commands a tag device 104 to actuate and/or activate one or more indicators 106 representing the compatibility and/or non-compatibility of the device 102 and the computing device 108. In further additional or alternative embodiments, the actuation signal instructs and/or commands the tag device 104 to actuate and/or activate one or more indicators 106 to include one or more characteristics and/or traits representing the level and/or degree of compatibility and/or non-compatibility of the device 102 and the computing device 108.

The actuation signal instructs and/or commands the tag device 104 to actuate and/or activate one or more indicators 106 consistent with the instruction(s) and/or command(s) in the actuation signal. That is, the actuation signal instructs and/or commands the tag device 104 to actuate and/or activate one or more indicators 106 representing the compatibility and/or non-compatibility of the device 102 and the computing device 108.

In some embodiments, the actuation signal instructs and/or commands the tag device 104 to actuate and/or activate an indicator 106 on the device 102 (see, e.g., computing system 100A and/or computing system 100C) in response to receiving the actuation signal. In additional or alternative embodiments, the actuation signal instructs and/or commands the tag device 104 to actuate and/or activate an indicator 106 on the tag device 104 (see, e.g., computing system 100B and/or computing system 100C) in response to receiving the signal from the computing device 108.

Referring back to FIG. 5A, a processor 506 may include any suitable non-volatile/persistent hardware and/or software configured to perform and/or facilitate performing functions and/or operations for determining device compatibility using tag devices 104. In various embodiments, the processor 506 includes hardware and/or software for executing instructions in one or more modules and/or applications that can perform and/or facilitate performing functions and/or operations for determining device compatibility using tag devices 104. The modules and/or applications executed by the processor 506 for determining device compatibility using tag devices 104 can be stored on and executed from a memory device 504 and/or from the processor 506.

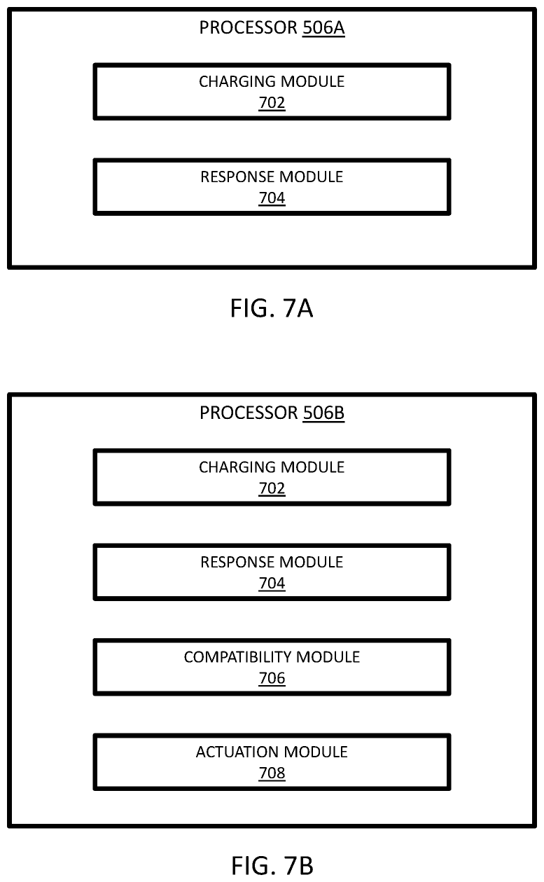

With reference to FIG. 7A, FIG. 7A is a schematic block diagram of one embodiment of a processor 506A. At least in the illustrated embodiment, the processor 506A includes, among other components and/or features, a charging module 702 and a response module 704 similar to the charging module and response module 604 included in the memory device 504A discussed with reference to FIG. 6A.

Referring to FIG. 7B, FIG. 7B is a schematic block diagram of another embodiment of a processor 506B. At least in the illustrated embodiment, the processor 506B includes, among other components and/or features, a charging module 702, a response module 704, a compatibility module 706, and an actuation module 708 similar to the charging module 602, response module 604, compatibility module 606, and actuation module 608 included in the memory device 504B discussed with reference to FIG. 6B.

Referring to FIG. 5B, FIG. 5B is a block diagram of another embodiment of a computing device 108B. At least in the illustrated embodiment, the computing device 108B includes, among other components and/or features, a set of I/O devices 502, a set of memory devices 504, a processor 506, and a bus 508 similar to the I/O device(s) 502, memory device(s) 504, processor 506 and bus 508 included in the computing device 108A illustrated in FIG. 5A. A difference between the computing device 108B and the computing device 108A is that the memory device(s) 504 of the computing device 108B are included in and/or form a portion of the processor 506, whereas the memory device(s) 504 of the computing device 108A is/are separate from and/or are device(s) that is/are independent from the processor 506.

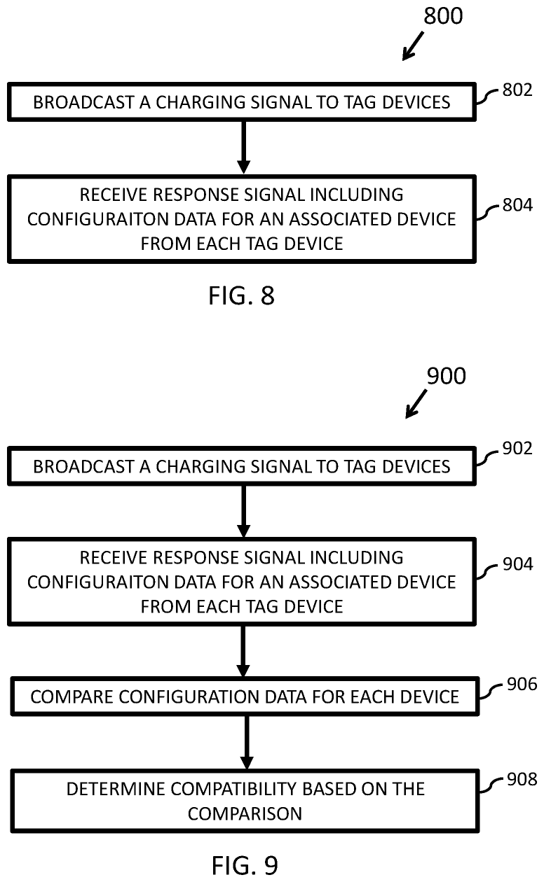

FIG. 8 is a schematic flow chart diagram illustrating one embodiment of a method 800 for determining device compatibility using tag devices 104. At least in the illustrated embodiment, the method 800 begins by a processor (e.g., processor 506) broadcasting a charging signal (block 802). The processor 506 may broadcast any suitable signal capable of charging a tag device 104 (e.g., a passive tag device 104). Further, the charging signal can include an RFID charging signal and/or a Bluetooth® charging signal, as discussed elsewhere herein.

In some embodiments, the method 800 further includes the processor 506 receiving a respective response signal from each of a plurality of tag devices 104 responsive to the tag devices 104 receiving the charging signal (block 804). Each respective response signal includes configuration data for a particular device 102 associated with each respective tag device 104 for determining compatibility between each device 102 and a computing device 108, as discussed elsewhere herein.

FIG. 9 is a schematic flow chart diagram illustrating another embodiment of a method 900 for determining device compatibility using tag devices 104. At least in the illustrated embodiment, the method 900 begins by a processor (e.g., processor 506) broadcasting a charging signal (block 902). The processor 506 may broadcast any suitable signal capable of charging a tag device 104 (e.g., a passive tag device 104). Further, the charging signal can include an RFID charging signal and/or a Bluetooth® charging signal, as discussed elsewhere herein.

In some embodiments, the method 900 further includes the processor 506 receiving a respective response signal from each of a plurality of tag devices 104 responsive to the tag devices 104 receiving the charging signal (block 904). Each respective response signal includes configuration data for a particular device 102 associated with each respective tag device 104 for determining compatibility between each device 102 and a computing device 108, as discussed elsewhere herein.

The processor 506 compares the configuration data of each of the devices 102 and configuration data for the computing device 108 to determine a match (block 906). Compatibility of the computing device 108 and each respective device 102 is determined based on the comparison (block 908).

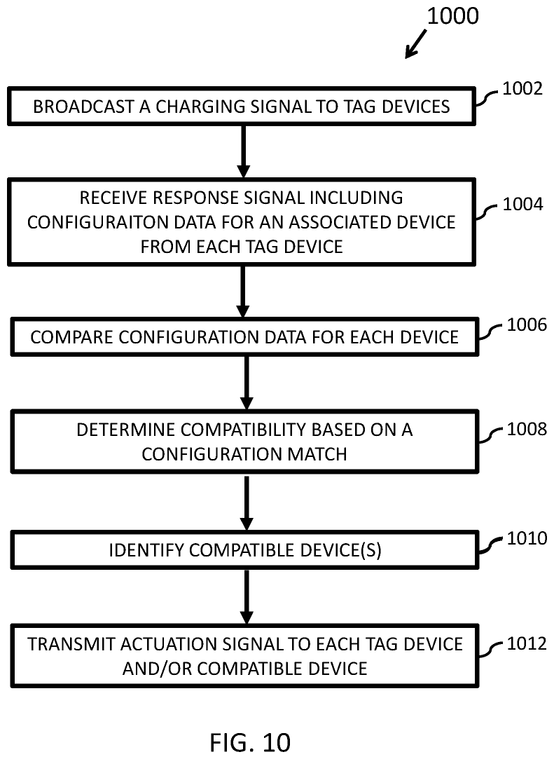

FIG. 10 is a schematic flow chart diagram illustrating another embodiment of a method 900 for determining device compatibility using tag devices 104. At least in the illustrated embodiment, the method 1000 begins by a processor (e.g., processor 506) broadcasting a charging signal (block 1002). The processor 506 may broadcast any suitable signal capable of charging a tag device 104 (e.g., a passive tag device 104). Further, the charging signal can include an RFID charging signal and/or a Bluetooth® charging signal, as discussed elsewhere herein.

In some embodiments, the method 1000 further includes the processor 506 receiving a respective response signal from each of a plurality of tag devices 104 responsive to the tag devices 104 receiving the charging signal (block 1004). Each respective response signal includes configuration data for a particular device 102 associated with each respective tag device 104 for determining compatibility between each device 102 and a computing device 108, as discussed elsewhere herein.

The processor 506 compares the configuration data of each of the devices 102 and configuration data for the computing device 108 to determine a match (block 1006) and determines compatibility of the computing device 108 and each respective device 102 based on the match (block 1008). The processor 506 identifies each device 102 that matches the computing device 108 as a compatible device (block 1010).

In response to identifying the compatible device(s), the processor 506 transmits an actuation signal to each compatible device and/or each tag device 104 associated with a compatible device (block 1012). In various embodiments, the actuation signal is configured to trigger each compatible device to activate a respective visual cue and/or indicator 106 on each compatible device and/or tag device 104.

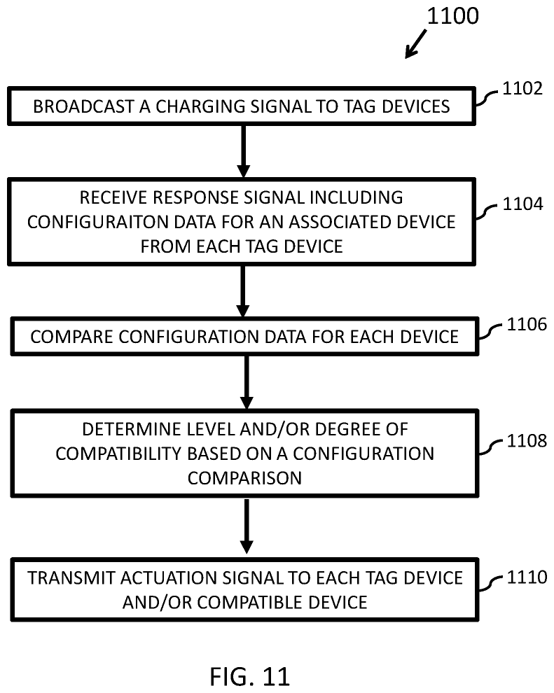

FIG. 11 is a schematic flow chart diagram illustrating another embodiment of a method 1100 for determining device compatibility using tag devices 104. At least in the illustrated embodiment, the method 1100 begins by a processor (e.g., processor 506) broadcasting a charging signal (block 1102). The processor 506 may broadcast any suitable signal capable of charging a tag device 104 (e.g., a passive tag device 104). Further, the charging signal can include an RFID charging signal and/or a Bluetooth® charging signal, as discussed elsewhere herein.

In some embodiments, the method 1100 further includes the processor 506 receiving a respective response signal from each of a plurality of tag devices 104 responsive to the tag devices 104 receiving the charging signal (block 1104). Each respective response signal includes configuration data for a particular device 102 associated with each respective tag device 104 for determining compatibility between each device 102 and a computing device 108, as discussed elsewhere herein.

The processor 506 compares the configuration data of each of the devices 102 and configuration data for the computing device 108 (block 1106) and determines a level and/or degree of compatibility of the computing device 108 and each respective device 102 based on the comparison (block 1108). In response to determining the level and/or degree of compatibility, the processor 506 transmits an actuation signal to each device 102 and/or each tag device 104 associated with a device 102 (block 1110). In various embodiments, the actuation signal is configured to trigger each device 102 to activate a respective visual cue and/or indicator 106 on each device 102 and/or tag device 104 that indicates the respective level and/or degree of compatibility of a device 102 and the computing device 108.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory configured to store code executable by the processor to:
broadcast a charging signal, and
receive a respective response signal from each of a plurality of tag devices responsive to the charging signal,
wherein each respective response signal includes first configuration data for a particular first device associated with each respective tag device for determining compatibility between each first device and a second device.

2. The apparatus of claim 1, wherein the processor is further configured to compare the first configuration data of each first device and second configuration data for the second device to determine a match.

3. The apparatus of claim 2, wherein the processor is further configured to:
determine compatibility of the second device and each respective first device based on the match; and
identify each first device that matches the second device as a compatible device.

4. The apparatus of claim 3, wherein:
the processor is further configured to transmit an actuation signal to each compatible device; and
the actuation signal is configured to trigger each compatible device to activate a respective visual cue on each compatible device.

5. The apparatus of claim 2, wherein the processor is further configured to:
identify each first device that matches the second device as a compatible device; and
determine a degree of compatibility between the second device and each respective first device that matches the second device.

6. The apparatus of claim 5, wherein:
the processor is further configured to transmit an actuation signal to each compatible device; and
the actuation signal is configured to trigger different compatible devices to activate different visual cues on each different compatible devices based on the degree of compatibility between the second device and each respective first device that matches the second device.

7. The apparatus of claim 1, wherein each tag device includes a passive tag attached to a respective first device.

8. A method, comprising:
broadcasting, by a processor, a charging signal; and
receiving a respective response signal from each of a plurality of tag devices responsive to the charging signal,
wherein each respective response signal includes first configuration data for a particular first device associated with each respective tag device for determining compatibility between each first device and a second device.

9. The method of claim 8, further comprising comparing the first configuration data of each first device and second configuration data for the second device to determine a match.

10. The method of claim 9, further comprising:
determining compatibility of the second device and each respective first device based on the match; and
identifying each first device that matches the second device as a compatible device.

11. The method of claim 10, further comprising:
transmitting an actuation signal to each compatible device,
wherein the actuation signal is configured to trigger each compatible device to activate a respective visual cue on each compatible device.

12. The method of claim 9, further comprising:
identifying each first device that matches the second device as a compatible device; and
determining a degree of compatibility between the second device and each respective first device that matches the second device.

13. The method of claim 12, further comprising:
transmitting an actuation signal to each compatible device,
wherein the actuation signal is configured to trigger each different compatible device to activate different visual cues on each different compatible device based on the degree of compatibility between the second device and each respective first device that matches the second device.

14. The method of claim 8, wherein broadcasting the charging signal comprises broadcasting the charging signal to each tag device that is attached to a respective first device.

15. A computer program product comprising a computer-readable storage device including code embodied therewith, the code executable by a processor to cause the processor to:
broadcast charging signal; and
receive a respective response signal from each of a plurality of tag devices responsive to the charging signal,
wherein each respective response signal includes first configuration data for a particular first device associated with each respective tag device for determining compatibility between each first device and a second device.

16. The computer program product of claim 15, wherein the executable code further causes the processor to compare the first configuration data of each first device and second configuration data for the second device to determine a match.

17. The computer program product of claim 16, wherein the executable code further causes the processor to:
determine compatibility of the second device and each respective first device based on the match; and
identify each first device that matches the second device as a compatible device.

18. The computer program product of claim 17, wherein:
the executable code further causes the processor to transmit an actuation signal to each compatible device; and
the actuation signal is configured to trigger each compatible device to activate a respective visual cue on each compatible device.

19. The computer program product of claim 16, wherein the executable code further causes the processor to:
identify each first device that matches the second device as a compatible device; and
determine a degree of compatibility between the second device and each respective first device that matches the second device.

20. The computer program product of claim 19, wherein:
the executable code further causes the processor to transmit an actuation signal to each compatible device; and
the actuation signal is configured to trigger different compatible devices to activate different visual cues on each different compatible device based on the degree of compatibility between the second device and each respective first device that matches the second device.
